(19) United States
(12) Patent Application Publication
(10) Pub. No.: US 2024/0183361 A1
(43) Pub. Date: Jun. 6, 2024

(54) SEAL FLUSH COOLER ASSEMBLY FOR ROTARY SHAFT EQUIPMENT SEALS

(71) Applicant: John Crane Inc., Morton Grove, IL (US)

(72) Inventor: Thomas Steigerwald, Chicago, IL (US)

(21) Appl. No.: 18/523,601

(22) Filed: Nov. 29, 2023

Related U.S. Application Data
(60) Provisional application No. 63/429,315, filed on Dec. 1, 2022.

(51) Int. Cl. F04D 29/12; F04D 27/00; F16J 15/34

(52) U.S. Cl. CPC F04D 29/128; F04D 27/00; F16J 15/3404; F05D 2270/303

(57) ABSTRACT

A pumping system includes a conduit that fluidly couples a pump outlet to a flush inlet to provide a path for liquid that exits the pump at the at outlet to be introduced into the chamber that housings a sliding seal via the flush inlet. A vaporizing heat exchanger is disposed along the conduit between the pump outlet and the flush inlet such that a cooling portion of the liquid that exits the pump is diverted from the conduit and the cooling portion of the liquid is used to cool fluid remaining in the conduit before it enters the flush inlet.

### CROSS REFERENCE TO RELATED APPLICATIONS

This application claims the benefit of an earlier filing date from U.S. Provisional Application Ser. No. 63/429,315 filed Dec. 1, 2022, the entire disclosure of which is incorporated herein by reference.

### TECHNICAL FIELD

This invention relates to rotary shaft equipment having mechanical seal assemblies providing a seal between a housing and rotatable shaft of the rotary shaft equipment. More particularly, it relates to such rotary shaft equipment that provide a seal flush liquid to a mechanical seal assembly.

### BACKGROUND

Mechanical seals are used to provide a seal between a rotating shaft and a stationary housing of a pump, compressor, turbine, or other rotating machine. End face mechanical seals generally include a primary seal interface comprising two relatively rotatable seal faces. Frictional wear between the seal faces can cause a gap to form therebetween, leading to excessive leakage. Accordingly, some end face seals require regular adjustment in order to maintain the appropriate or axial position of an axially shiftable seal member (also known as “seal height”) in order to account for such wear.

Various biasing mechanisms have been contemplated to provide a closing force to automatically accommodate wear. Such biasing mechanism have included single and multiple coil springs, and metal bellows.

Pusher seal assemblies comprise a dynamic secondary seal (such as an o-ring) to provide a seal between the shaft and the seal members themselves. The dynamic secondary seal of pusher seals is generally configured to move axially with the axially shiftable seal member. This axial movement relative to the shaft can cause fretting or shredding of the secondary seal due to friction.

Non-pusher seals generally feature a secondary shaft seal that is not intended to move axially relative to the shaft, such as an o-ring (generally used with metallic bellows seals), or an elastomeric bellows.

Regardless of the type of seal, the seal will often be provided a flush liquid to lubricate and cool the seal faces. The flush liquid can be taken from outlet of the rotary machine (e.g., pump) and provided back into the seal chamber at a pressure that causes it to be directed back into the chamber of the seal.

### SUMMARY

Embodiments of the present disclosure meet the need to provide a cooled flush liquid to mechanical seals. The system includes a seal assembly that includes flush input and a conduit configured for connection to an output of a rotary machine that connects the output to the flush input. The system also includes a heat exchanger thermally coupled to the conduit. The system also includes cooling spur. The cooling spur is fluidly connected to the conduit and thermally coupled to the heat exchanger. The colling spur can divert a small portion of the flush liquid and cause it to vaporize. The vaporization will result in a gas or gas liquid mixture (vaporized fluid) that is at a lower temperate than the flush liquid. As both the cooled vaporized fluid and the flush liquid are thermally coupled to the heat exchanger, the cooled vaporized fluid can be used to cool the flush liquid.

One embodiment is directed to pump system that includes a pump having a housing and a pump outlet and that is driven by a rotating shaft and a mechanical seal assembly coupled to and surrounding the rotating shaft that seals a liquid in a chamber of the pump so that liquid in the chamber exits the pump via the pump outlet. The mechanical seal assembly is disposed in the housing and includes: first and second rings configured to that first ring rotates with the shaft and relative to the second ring; and a gland plate coupled to the housing such that it defines a cooling chamber between the housing and the first and second rings, the gland plate including a flush inlet that is in fluid communication with the chamber. The system also includes: a conduit that fluidly couples the outlet to the flush inlet to provide a path for liquid that exits the pump at the at outlet to be introduced into the chamber via the flush inlet; and a vaporizing heat exchanger disposed along the conduit between the pump outlet and the flush inlet such that a cooling portion of the liquid that exits the pump is diverted from the conduit and the cooling portion of the liquid is used to cool fluid remaining in the conduit before it enters the flush inlet.

In any prior pump system, the vaporizing heat exchanger can include a heat exchanger; a manifold fluidly connected to the conduit configured to divert the cooling portion of the liquid from the conduit; and a cooling spur conduit fluidly connected to the manifold, the cooling spur conduit including an orifice vaporizer that converts the cooling portion of the liquid into a gaseous state.

In any prior pump system, the conduit and the cooling spur conduit can be thermal coupled to the heat exchanger such that heat from the conduit is transferred to the cooling spur conduit.

In any prior pump system, the system can further include a control valve disposed that controls flow through the manifold into the cooling spur conduit.

In any prior pump system, the control valve can be disposed between the manifold and the orifice vaporizer

In any prior pump system, the system can further include a temperature sensor that measures a temperature of a fluid in the system.

In any prior pump system, the control valve is opened when the sensor measures a temperature that is above a threshold.

In any prior pump system, the sensor measures the temperature of a fluid in conduit at or near the flush inlet.

In any prior pump system, the sensor measures the temperature of a fluid in the cooling chamber.

Also disclose is a method of controlling the cooling of a mechanical seal assembly used in pump assembly. The pump assembly can be the same or similar as any prior pump system disclosed herein or otherwise herein. The method includes coupling an outlet of the pump to the flush inlet to provide a path for liquid that exits the pump at the at outlet to be introduced into the chamber via the flush inlet; and coupling a vaporizing heat exchanger along the path between the pump outlet and the flush inlet such that a cooling portion of the liquid that exits the pump is diverted from the path and the cooling portion of the liquid is used to cool fluid remaining in the path before it enters the flush inlet.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures.

FIG. 1 is a cross-sectional view showing a rotating machine with a mechanical seal and a vaporizing heat exchanger according to one embodiment;

FIG. 2 is a cross-sectional view showing a rotating machine with a mechanical seal and a vaporizing heat exchanger and an orifice according to one embodiment; and

FIG. 3 is a more detailed view of a vaporizing heat exchanger according to one embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

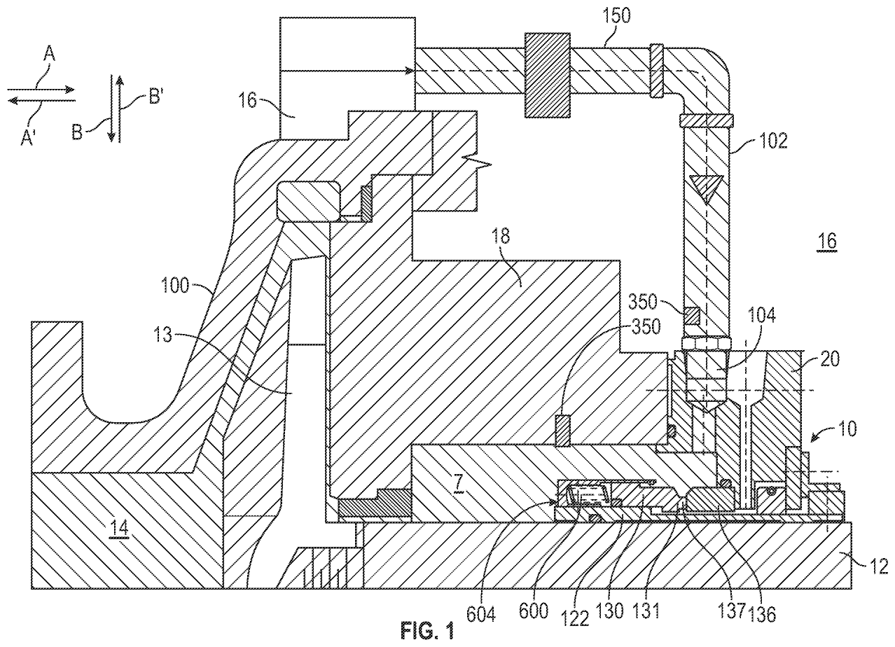

FIG. 1 is a cross-sectional view showing a rotating machine 100 such as pump having mechanical seal assembly 10 that acts on seals a liquid in a chamber 14 of the machine 100. FIG. 1 is described in general to both set forth components in embodiments discussed below and to describe the systems to which the embodiments herein may improve. Thus, any element described with relation to FIG. 1 can also form part of any embodiment disclosed herein.

The seal assembly 10 is arranged such that is surrounds the rotating shaft 12 and acts on a liquid (e.g., a hydrocarbon) in the chamber 14 so that is does not escape and possibly enter the atmosphere 17. The seal assembly 10 can be arranged coaxial of the shaft 12 in a bore defined by an annular housing 18 coaxial of shaft 12. Various stationary (or non-rotating) components of seal assembly 10 can be operably coupled to housing 18, or a gland plate 20, which is in turn also operably coupled to housing 18. Stated differently that above, the seal assembly 10 ensures that the primary path that liquid can exit the chamber 14 is via the pump outlet 16 and so that little to no fluid can exit the chamber 14 via a space between the shaft 12 and the housing 18.

From time to time certain directions will be used herein. An outboard direction is the direction extending in the direction of arrow A and the inboard direction (e.g., towards the chamber 14 described below) is in the opposite direction as indicated by arrow A′. The radially inward direction is in the direction of arrow B which is directed toward a center of the shaft 12 and the radially outward direction is in the opposite direction as indicated by arrow B′. Further, the fluid that has not yet entered the pump (or before it is expelled therefrom) may be referred to as “upstream” of the pump and fluid that has left the pump is “downstream” of the pump 100.

In the case where the chamber is defined in a pump, fluid in chamber 14 is pumped through the pump due to rotation of the shaft 12. In more detail, the shaft 12 will turn elements such as impeller 13 attached thereto and create an operational pressure in the chamber 12. In such cases, the pressure at a radially outward edge of the impeller 13 is greater than in the chamber 14 and cause the fluid to be pumped out the chamber 14 at pump outlet 16.

In general operation, the seal 10 is in a positive pressure scenario. In such a scenario (and more fully described below), cooling or “flush” fluid is provided into a cooling fluid chamber 7 defined on the outer diameter of the seal assembly 10. As shown the flush fluid is provided to the cooling fluid chamber 7 from the outlet 16 of the pump 100 via flush conduit 102. The flush conduit 102 is connected to a flush inlet 104 in the gland plate 20. As such, the flush conduit 102 that fluidly couples the outlet 16 to the flush inlet 104 to provide a path for liquid (e.g., flush fluid) that exits the pump 100 at the at pump outlet 16 to be introduced into the cooling chamber 7 via the flush inlet 104.

In the following discussion an example seal 10 is described. This illustrated seal 10 is an elastomer o-ring seal but it shall be understood that the teachings herein can be applied to any type of rotating seal that includes two rings.

The illustrated seal 10 includes two rings 130, 136 having opposing faces 131, 137 that rotate relative to one another in operation. The rings 130, 136 may be referred to, respectively, as primary and mating rings herein. The mating ring 136 can be fixedly attached to the annular housing 18 or to a gland plate 20 as illustrated. The primary ring 130 is connected to the shaft 12 by an assembly 602. The assembly 602 as illustrated includes a carrier ring 604 and a sleeve member 22 that is fixedly attached to the shaft 12. In operation, the shaft 12 moves axially forward and backward along arrows A and A′. The carrier ring 604 can be fixedly attached to the sleeve member 22 and can encase some or all of the primary ring 130.

In general, during operation a liquid film develops between the faces 131, 137as the faces rotate relative to one another. The rotation is caused by rotation of the shaft 12.

In this example, a primary or first seal biasing mechanism 600 in the carrier ring 602 urges the primary and mating rings 130, 136 of the seal together. In particular, the primary or first seal biasing mechanism 600 is connected to the primary ring 130 and urges it towards the mating ring 136. Of course, this configuration could be reversed without departing from the teachings herein.

The liquid received from flush inlet 104 is generally held at the OD of the seal 10 where the faces 131/137 meet. Of course, some of the liquid may enter re-enter the chamber 14 during normal operation. Indeed, the pressure at the inner diameter 33 of the impeller 13 may be lower than the pressure in the cooling fluid chamber 7 and, thus, provide a flow path from the cooling fluid chamber 7 back into the chamber 14.

It has been discovered by the inventors hereof that the in some cases, if the ambient temperature is too high (or the output pressure the pump is too low) that the liquid provided into cooling fluid chamber 7 may at least partially flash to gas. To prevent or reduce the occurrence thereof, a vaporizing heat exchanger 150 can be provided on the conduit 14. The vaporizing heat exchanger 150 can be located anywhere along the conduit 14.

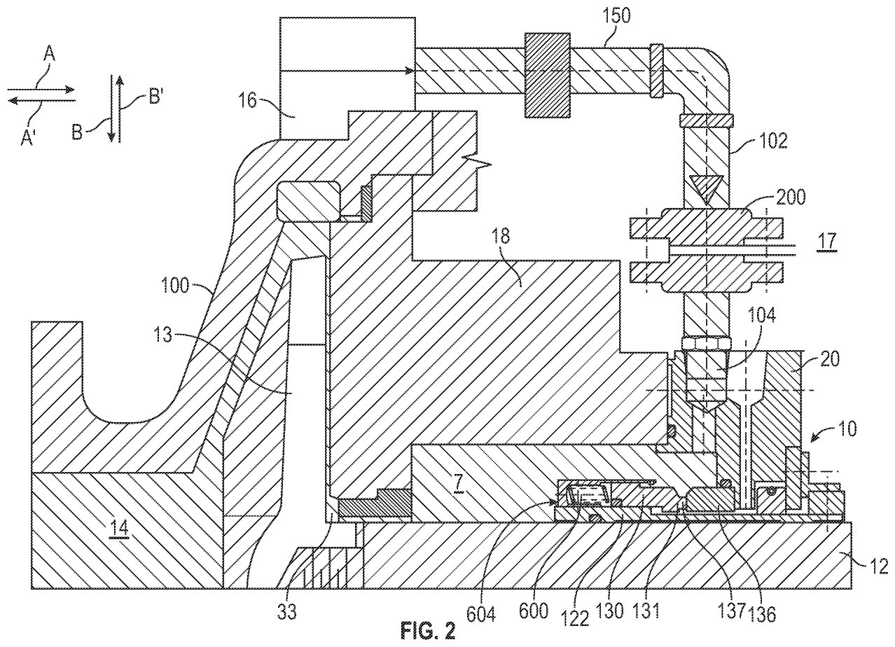

In some cases, an orifice 200 can be provided along the conduit 14 between the outlet 16 and the flush input 104 as shown in FIG. 2. In such a case, the vaporizing heat exchanger 150 may be disposed between the outlet 16 and the orifice. The skilled artisan will realize that FIGS. 1 and 2 resemble piping plans 11 and 12. The teachings herein can be applied to either piping plan or to others.

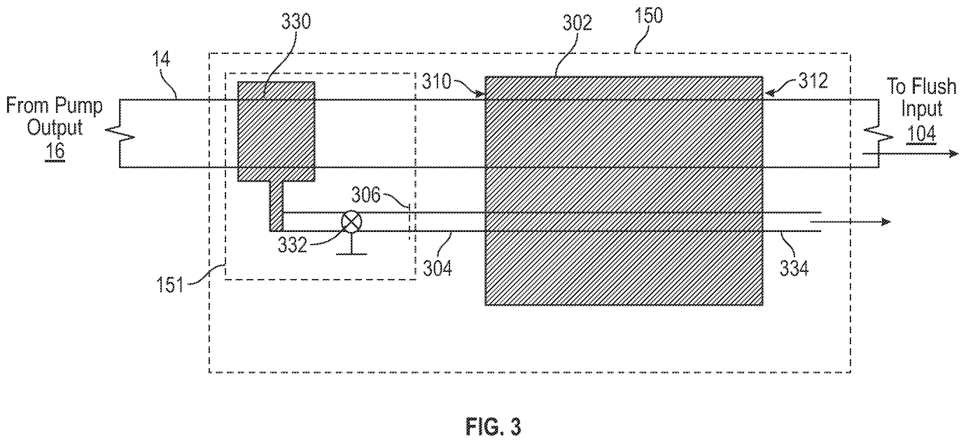

FIG. 3 shows a more detailed version of a vaporizing heat exchanger (VPX) 150 according to one embodiment. As discussed above, the VPX 150 is connected to the conduit 14 such that the conduit 14 passes through the VPX 150 and liquid in the conduit 14 is cooled so that it remains in a liquid form. Thus, the output of the VPX 150 along conduit 14 is more likely to remain in a liquid form when delivered to the flush input 104.

The VPX 150 is generally disposed along the conduit 14 between the pump outlet 16 and flush inlet 104 such that a cooling portion of the liquid that exits the pump 14 is diverted from the conduit 14 and the cooling portion of the liquid is used to cool fluid remaining in the conduit 14 before it enters the flush inlet 104. As will be understood, the cooling portion of the liquid will be provided to the cooling spur conduit 304 described below.

The VPX 150 includes a heat exchanging element (or simply, heat exchanger) 302. The heat exchanger 302 is illustrated as parallel flow heat exchanger but other types of heat exchangers (e.g., cross or counter flow heater exchangers) could be utilized. Although the heat exchanger 302 is illustrated as having a single pass configuration, it should be appreciated that in other embodiments, at least one of the fluid channels may make multiple passes through the heat exchanger. Further, the channels may be arranged in any suitable flow configuration at the heat exchanger, such as a cross-flow, a parallel flow, a counter-flow, or any combination thereof. Examples of the type of heat exchangers that may be used, include, but are not limited to, double pipe, shell and tube, plate, plate and shell, adiabatic shell, plate fin, pillow plate, and fluid heat exchangers

The heat exchanger 302 has a main input 310 through which liquid in the conduit 14 passes. The heat exchanger 302 also includes a main output 312 through which liquid provided at the main input 310 exits the heat exchanger 302. To this end, it shall be understood that the heat exchanger 302 can define a portion of the conduit 14 as the conduit passes from the outlet 16 to flush input 104. That being said, the conduit 14 could be a continuous element that passes through and is in thermal contact with heat exchanger 150 (e.g., the heat exchanger 150 could be in thermal contact with an outer surface of the conduit 14). It shall be understood that while the conduit 14 is shown as continuous through the heat exchanger 302, all that is required is that the heat exchanger 302 allow for flow through it from the main input 310 to the main output 312.

The VPX 150 also includes a cooling spur segment 151. The cooling bypass segment 151 can include means for diverting a portion of the liquid in the conduit upstream of the heat exchanger 150 into the cooling spur 304. As shown the cooling bypass segment 151 includes the cooling spur conduit 304 and a manifold 330. The manifold 330 is fluidly coupled to the conduit 14 and captures a fraction of the seal flush in the conduit 14 and diverts to the cooling spur conduit 304. The cooling bypass segment 151 can also include a control valve 332. The control valve 332 can be manually or automatically controlled to open or close and thereby allow liquid in the conduit 14 to be diverted into the cooling spur conduit. In one example, a temperature of the liquid in the conduit 14 as it enters the flush inlet 104 can be measured by a sensor 350 (FIG. 1). Based on the temperature, the control valve 332 can be opened or closed. In one embodiment, when the temperature measured by the sensor 350 exceeds a threshold, the control valve 332 can be opened to allow for the liquid in the conduit to be cooled in the manner described below. While the sensor 350 is shown at or near the inlet 104, the temperature could be measured at other locations such at the cooling chamber 7.

In the event that the control valve 332 is opened, a small fraction of the liquid in the conduit is diverted into the cooling spur conduit 304. The cooling spur conduit 304 includes an orifice vaporizer 360 disposed along its path. The orifice vaporizer 360 is shown as being downstream of the control valve 332 but this exact location is not required.

The orifice vaporizer 360 can be a constricting element sized and configured so that a liquid (e.g, a petrochemical) that passes through it flashes to a gaseous state. This change of state will result in the gas in the cooling spur conduit 304 and, thus, the cooling spur conduit 304 where it enters or otherwise contacts the heat exchanger 302 being at a lower temperature than the conduit 14. In this manner, heat can be extracted from the conduit 14 and absorbed by the cooling spur conduit 304. The cooling spur conduit 304 exits the heat exchanger 302 at a cooling spur conduit outlet 334 and can be disposed of or reintroduced into the system in which the VPX 150 is provided.

Similar to the discussion above relative to the conduit 14, it shall be understood that the heat exchanger 302 can define a portion of the cooling spur conduit 304 as the cooling spur conduit 304 passes from the manifold to the cooling spur conduit outlet 334 That being said, the cooling spur conduit 304 could be a continuous element that passes through and is in thermal contact with heat exchanger 150 (e.g., the heat exchanger 150 could be in thermal contact with an outer surface of the cooling spur conduit 304). It shall be understood that while the cooling spur conduit 304 is shown as continuous through the heat exchanger 302, all that is required is that the heat exchanger 302 allow for flow through it from the manifold 330 to the cooling spur conduit outlet 334.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A pump system comprising:
a pump having a housing and a pump outlet and that is driven by a rotating shaft;
a mechanical seal assembly coupled to and surrounding the rotating shaft that seals a liquid in a chamber of the pump so that liquid in the chamber exits the pump via the pump outlet, the mechanical seal assembly being disposed in the housing and including:
first and second rings configured to that first ring rotates with the shaft and relative to the second ring; and
a gland plate coupled to the housing such that it defines a cooling chamber between the housing and the first and second rings, the gland plate including a flush inlet that is in fluid communication with the chamber;
a conduit that fluidly couples the outlet to the flush inlet to provide a path for liquid that exits the pump at the at outlet to be introduced into the chamber via the flush inlet; and
a vaporizing heat exchanger disposed along the conduit between the pump outlet and the flush inlet such that a cooling portion of the liquid that exits the pump is diverted from the conduit and the cooling portion of the liquid is used to cool fluid remaining in the conduit before it enters the flush inlet.

2. The system of claim 1, wherein the vaporizing heat exchanger includes:
a heat exchanger;
a manifold fluidly connected to the conduit configured to divert the cooling portion of the liquid from the conduit; and
a cooling spur conduit fluidly connected to the manifold, the cooling spur conduit including an orifice vaporizer that converts the cooling portion of the liquid into a gaseous state.

3. The system of claim 2, wherein the conduit and the cooling spur conduit are thermal coupled to the heat exchanger such that heat from the conduit is transferred to the cooling spur conduit.

4. The system of claim 3, further comprising:
a control valve disposed that controls flow through the manifold into the cooling spur conduit.

5. The system of claim 4, wherein the control valve is disposed between the manifold and the orifice vaporizer.

6. The system of claim 4, further comprising a temperature sensor that measures a temperature of a fluid in the system.

7. The system of claim 6, wherein the control valve is opened when the sensor measures a temperature that is above a threshold.

8. The system of claim 7, wherein the sensor measures the temperature of a fluid in conduit at or near the flush inlet.

9. The system of claim 7, wherein the sensor measures the temperature of a fluid in the cooling chamber.

10. A method of controlling the cooling of a mechanical seal assembly used in pump assembly, wherein the mechanical seal assembly is coupled to and surrounds a rotating shaft of the pump, includes: first and second rings configured to that first ring rotates with the shaft and relative to the second ring and a gland plate coupled to the pump such that it defines a cooling chamber between a housing of the pump and the first and second rings, the gland plate including a flush inlet;
the method comprising:
coupling an outlet of the pump to the flush inlet to provide a path for liquid that exits the pump at the at outlet to be introduced into the chamber via the flush inlet; and
coupling a vaporizing heat exchanger along the path between the pump outlet and the flush inlet such that a cooling portion of the liquid that exits the pump is diverted from the path and the cooling portion of the liquid is used to cool fluid remaining in the path before it enters the flush inlet.

11. The method of claim 10, wherein the path is defined by a conduit and wherein the vaporizing heat exchanger includes:
a heat exchanger;
a manifold fluidly connected to the conduit configured to divert the cooling portion of the liquid from the conduit; and
a cooling spur conduit fluidly connected to the manifold, the cooling spur conduit including an orifice vaporizer that converts the cooling portion of the liquid into a gaseous state.

12. The method of claim 11, wherein coupling includes thermally coupling the conduit and the cooling spur conduit to the heat exchanger such that heat from the conduit is transferred to the cooling spur conduit.

13. The method of claim 12, further comprising:
disposing a control valve to control flow through the manifold into the cooling spur conduit.

14. The method of claim 13, wherein the control valve is disposed between the manifold and the orifice vaporizer.

15. The method of claim 13, further comprising connecting a temperature sensor so that it that measures a temperature of a fluid provided to the mechanical seal assembly.

16. The method of claim 15, wherein the control valve is opened when the sensor measures a temperature that is above a threshold.

17. The method of claim 16, wherein the sensor measures the temperature of a fluid in the conduit at or near the flush inlet.

18. The method of claim 16, wherein the sensor measures the temperature of a fluid in the cooling chamber.
